(19) United States
(12) Patent Application Publication
(10) Pub. No.: US 2019/0305983 A1
(43) Pub. Date: Oct. 3, 2019

(54) METHOD AND APPARATUS FOR CONFIGURING BACKUP PATH IN VEHICLE NETWORK

(71) Applicants: Hyundai Motor Company, Seoul (KR); Kia Motors Corporation, Seoul (KR)

(72) Inventors: Dong Ok Kim, Hwaseong (KR); Chul Min Kim, Hwaseong (KR); Seung Su Kim, Hwaseong (KR)

(21) Appl. No.: 16/369,734

(22) Filed: Mar. 29, 2019

Related U.S. Application Data
(60) Provisional application No. 62/650,034, filed on Mar. 29, 2018.

(30) Foreign Application Priority Data
Feb. 28, 2019 (KR) 10-2019-0023767

(51) Int. Cl. H04L 12/40; G06F 13/42

(52) U.S. Cl. CPC H04L 12/40013; H04L 2012/6448; G06F 13/4247

(57) ABSTRACT

An operation method of a switch in a vehicle network may include: transmitting a first signal to a first end node through a first path connecting the switch and the first end node; detecting a failure in the first path; configuring a second path connecting the switch and the first end node; receiving a second signal from a second end node; determining whether a destination of the second signal is the first end node; and in response to determining that the destination of the second signal is the first end node, transmitting the second signal through the second path.

### CROSS-REFERENCE TO RELATED APPLICATIONS

This application claims the benefit of priority to U.S. Provisional Patent Application No. 62/650,034, filed on Mar. 29, 2018 in the U.S. Patent and Trademark Office, and Korean Patent Application No. 10-2019-0023767, filed on Feb. 28, 2019 in the Korean intellectual Property Office (KIPO), the entirety of which is incorporated by reference as if fully set forth herein.

### TECHNICAL FIELD

The present disclosure relates to vehicle network technology, and more specifically, to a method and an apparatus for configuring a plurality of paths and performing functions through a backup path when a failure occurs in a path among the plurality of paths.

### BACKGROUND

The number and variety of devices installed in vehicles have increased significantly in accordance with the recent digitalization of vehicle parts. Generally, electronic devices may be used throughout the vehicle, for example, a power train control system (e.g., an engine control system, an automatic transmission control system, or the like), a body control system (e.g., a body electronic equipment control system, a convenience apparatus control system, a lamp control system, or the like), a chassis control system (e.g., a steering apparatus control system, a brake control system, a suspension control system, or the like), a vehicle network (e.g., a controller area network (CAN), a FlexRay-based network, a media oriented system transport (MOST)-based network, or the like), a multimedia system (e.g., a navigation apparatus system, a telematics system, an infotainment system, or the like), and so forth.

The electronic devices used in each of these systems are connected via a vehicle network, which supports functions of the electronic devices. For instance, the CAN may support a transmission rate of up to 1 Mbps and support automatic retransmission of colliding messages, error detection based on a cycle redundancy interface (CRC), or the like. The FlexRay-based network may support a transmission rate of up to 10 Mbps and support simultaneous transmission of data through two channels, synchronous data transmission, or the like. The MOST-based network is a communication network for high-quality multimedia, which may support a transmission rate of up to 150 Mbps.

Most enhanced safety systems of a vehicle, such as telematics systems and infotainment systems, require higher transmission rates and system expandability. However, the CAN, FlexRay-based network, and the like may not sufficiently support such requirements. The MOST-based network, in particular, may support a higher transmission rate than the CAN or the FlexRay-based network. However, applying the MOST-based network to vehicle networks can be costly. Due to these limitations, an Ethernet-based network is often utilized as a vehicle network. The Ethernet-based network may support bi-directional communication through one pair of windings and may support a transmission rate of up to 10 Gbps.

Institute of Electrical and Electronics Engineers (IEEE) 802.1CB specifies a method for redundant transmission of signals through two paths. However, if there is only one path between a talker and a listener, such as when a switch and an end node are connected in one-to-one manner, and the corresponding path fails, the transmission may be unable to be performed because there is no separate path. Therefore, a method of establishing a separate communication path for stable communication between the switch and the end node may be required.

### SUMMARY

The present disclosure provides a method and an apparatus for configuring a plurality of paths in a vehicle network, and for performing functions through a backup path when a failure occurs in a part of the plurality of paths.

In accordance with embodiments of the present disclosure, an operation method of a switch in a vehicle network may include: transmitting a first signal to a first end node through a first path connecting the switch and the first end node; detecting a failure in the first path; configuring a second path connecting the switch and the first end node; receiving a second signal from a second end node; determining whether a destination of the second signal is the first end node; and in response to determining that the destination of the second signal is the first end node, transmitting the second signal through the second path.

A preamble of the second signal may include an identifier of the destination, and the identifier may be used to determine whether the destination of the second signal is the first end node.

The first path and the second path may have different transmission speeds.

The second path may include a section in which a plurality of end nodes are connected in a daisy chain scheme.

The switch may include a controller unit, a first physical (PHY) layer unit, and a second PHY layer unit, the first path may be connected to the first PHY layer unit, and the second path may be connected to the second PHY layer unit.

The detecting of the failure may include informing, by the first PHY layer unit, the controller unit of the failure in the first path through a medium dependent interface (MDI), such that the controller unit recognizes the failure in the first path.

The transmitting of the second signal through the second path may include transmitting the second signal through the second path in response to determining that the second signal meets a preconfigured threshold.

The operation method may further comprise receiving, by the first PHY layer unit, a third signal from a third end node; transferring, by the first PHY layer unit, the third signal to the third end node; identifying, by the controller unit, a destination and a path of the third signal; selecting a PHY layer unit among the first and second PHY layer units for transmitting the third signal based on the destination and the path of the third signal; and transmitting the third signal through the selected PHY layer unit.

Furthermore in accordance with embodiments of the present disclosure, a switch in a vehicle network may include a processor and a memory storing at least one instruction executable by the processor. When the at least one instruction is executed, the processor may be configured to: transmit a first signal to a first end node through a first path connecting the switch and the first end node; detect a failure in the first path; configure a second path connecting the switch and the first end node; receive a second signal from a second end node; determine whether a destination of the second signal is the first end node; and in response to determining that the destination of the second signal is the first end node, transmit the second signal through the second path.

A preamble of the second signal may include an identifier of the destination, and the identifier may be used to determine whether the destination of the second signal is the first end node.

The second path may include a section in which a plurality of end nodes are connected in a daisy chain scheme.

The switch may further include a controller unit, a first physical (PHY) layer unit, and a second PHY layer unit, the first path may be connected to the first PHY layer unit, and the second path may be connected to the second PHY layer unit.

The processor may be further configured to cause the first PHY layer unit to inform the controller unit of the failure in the first path through a medium dependent interface (MDI), such the controller unit may recognize the failure in the first path.

The processor may be further configure transmit the second signal through the second path in response to determining that the second signal meets a preconfigured threshold.

The processor may be further configured to cause the first PHY layer unit to receive a third signal from a third end node; cause the first PHY layer unit to transfer the third signal to the third end node; cause the controller unit to identify a destination and a path of the third signal; select a PHY layer unit among the first and second PHY layer units for transmitting the third signal based on the destination and the path of the third signal; and transmit the third signal through the selected PHY layer unit.

Furthermore, in accordance with embodiments of the present disclosure, an operation method of a first end node in a vehicle network, wherein the first end node includes a first physical (PHY) layer unit, a second PHY layer unit, and a controller unit, the first PHY unit is connected to a switch, and the second PHY unit is connected to second and third end nodes. The operation method may include: receiving, by the second PHY unit, a signal from the second end node; identifying, by the second PHY layer unit, a destination identifier (ID) from the signal; determining whether the destination ID is different from an ID of the first end node; and in response to determining that the destination ID is different from the ID of the first end node, transmitting the signal to the third end node.

The operation method may further comprise: detecting a failure in the first PHY layer unit; informing, by the first PHY layer unit, the controller unit of the failure in the first PHY layer unit through a medium dependent interface (MDI); recognizing, by the controller unit, the failure in the first PHY layer unit; and transmitting, by the second PHY layer unit, the signal.

A transmission speed of the first PHY layer unit may be higher than a transmission speed of the second PHY layer unit.

The first PHY layer unit and the second PHY layer unit may be connected to the controller unit via a media independent interface (xMII).

The first, second and third end nodes may be connected in a daisy chain scheme.

According to the embodiments of the present disclosure, when a link, which is a primary path between a switch and an end node, fails in a vehicle network, signal transmission can be performed using a backup path. Therefore, safety of the vehicle network can be enhanced in situations such as during autonomous driving. Also, by using a single IP/MAC address, software complexity due to using multiple addresses can be reduced. Further, when the backup path is used due to the failure of the primary path, and a transmission speed of the backup path is different from that of the main path, restricting bandwidths of other primary paths in normal operation based on a policy can result in their transmission speeds being matched to each other, resulting in communication stability.

### BRIEF DESCRIPTION OF DRAWINGS

Embodiments of the present disclosure will become more apparent by describing in detail forms of the present disclosure with reference to the accompanying drawings, in which:

FIG. 1 is a block diagram illustrating a first embodiment of a vehicle network topology;

FIG. 2 is a block diagram illustrating a first embodiment of a communication node belonging to a vehicle network;

FIG. 3 is a block diagram illustrating an embodiment of a communication node for which a backup path is configured;

FIG. 4 is a block diagram illustrating a first embodiment of a vehicle network;

FIG. 5 is a sequence chart illustrating an embodiment of a communication method through a primary path between a switch and an end node in the vehicle network of FIG. 4;

FIG. 6 is a sequence chart illustrating a first embodiment of a communication method through a backup path between a switch and an end node in the vehicle network of FIG. 4; and

FIG. 7 is a sequence chart illustrating a second embodiment of a communication method through a backup path between a switch and an end node in the vehicle network of FIG. 4.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular forms only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although forms are described herein as using a plurality of units to perform the exemplary process, it is understood that the exemplary processes may also be performed by one or plurality of modules. Additionally, it is understood that a controller/controller unit/control unit may perform one or more of the processes described further below, and the term controller/controller unit/control unit refers to a hardware device that includes a memory and a processor. The memory is configured to store the modules, and the processor is specifically configured to execute said modules to perform one or more processes which are described further below. Moreover, it is understood that the units or modules described herein may embody a controller/controller unit/control unit for controlling operation of the unit or module.

Furthermore, control logic of the present disclosure may be embodied as non-transitory computer readable media on a computer readable medium containing executable program instructions executed by a processor, controller/control unit or the like. Examples of the computer readable mediums include, but are not limited to, read-only memory (ROM), random access memory (RAM), compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Since the present disclosure may be variously modified and have several forms, specific embodiments will be shown in the accompanying drawings and be described in detail in the detailed description. It should be understood, however, that it is not intended to limit the present disclosure to the specific embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without being departed from the scope of the present disclosure and the second component may also be similarly named the first component. The term “and/or” means any one or a combination of a plurality of related and described items.

When it is mentioned that a certain component is “coupled with” or “connected with” another component, it should be understood that the certain component is directly “coupled with” or “connected with” to the other component or a further component may be located therebetween. In contrast, when it is mentioned that a certain component is “directly coupled with” or “directly connected with” another component, it will be understood that a further component is not located therebetween.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless otherwise defined, all terms (including technical and scientific terms) used herein have the same meaning as commonly understood by one of ordinary skill in the art to which this disclosure belongs. Terms such as terms that are generally used and have been in dictionaries should be construed as having meanings matched with contextual meanings in the art. In this description, unless defined clearly, terms are not ideally, excessively construed as formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

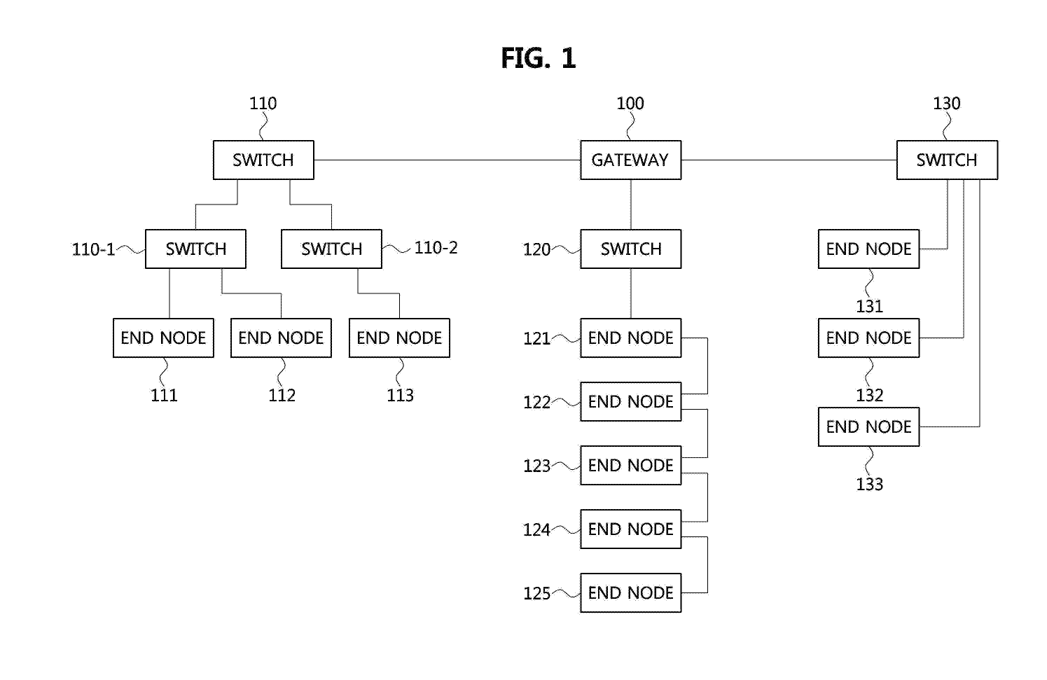

FIG. 1 is a block diagram illustrating a first embodiment of a vehicle network topology.

As shown in FIG. 1, a communication node constituting a vehicle network may be a gateway, a switch (or bridge), or an end node. The gateway 100 may be connected with at least one switch 110, 110-1, 110-2, 120, and 130, and may be configured to connect different networks. For example, the gateway 100 may support connections between a switch which supports a controller area network (CAN) (or, FlexRay, media oriented system transport (MOST), or local interconnect network (LIN)) network) and a switch which supports an Ethernet protocol. Each of the switches 110, 110-1, 110-2, 120, and 130 may be connected to at least one of end nodes 111, 112, 113, 121, 122, 123, 124, 125, 131, 132, and 133. Each of the switches 110, 110-1, 110-2, 120, and 130 may interconnect the end nodes 111, 112, 113, 121, 122, 123, 124, 125, 131, 132, and 133, and control at least one of the end nodes 111, 112, 113, 121, 122, 123, 124, 125, 131, 132, and 133 connected to the switch.

Each of the end nodes 111, 112, 113, 121, 122, 123, 124, 125, 131, 132, and 133 may include an electronic control unit (ECU) configured to control various types of devices mounted within a vehicle. For example, each of the end nodes 111, 112, 113, 121, 122, 123, 124, 125, 131, 132, and 133 may include an ECU included in an infotainment device (e.g., a display device, a navigation device, and an around view monitoring device).

The communication nodes (i.e., gateways, switches, end nodes, etc.) constituting the vehicle network may be connected in a star topology, a bus topology, a ring topology, a tree topology, a mesh topology, or the like. Further, each of the communication nodes constituting the vehicle network may support the CAN protocol, the FlexRay protocol, the MOST protocol, the LIN protocol, the Ethernet protocol, or the like. A communication node belonging to the vehicle network may be configured as follows.

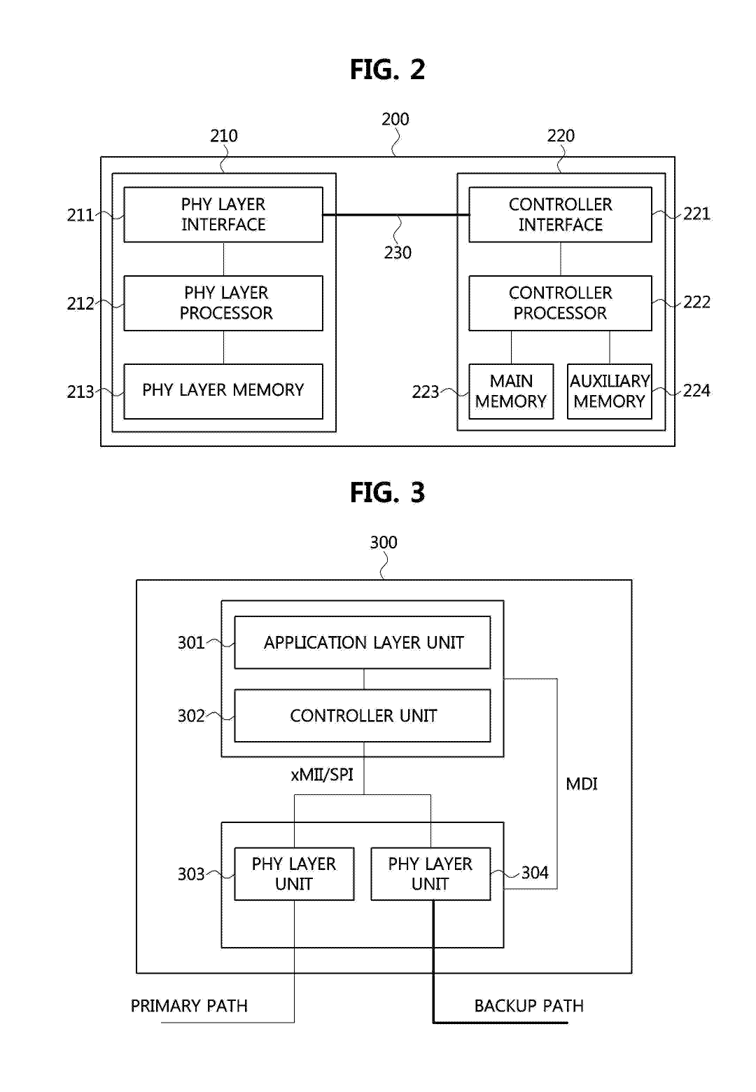

FIG. 2 is a block diagram illustrating a first embodiment of a communication node belonging to a vehicle network.

As shown in FIG. 2, a communication node 200 constituting a vehicle network may include a physical (PHY) layer unit 210 and a controller unit 220. The communication node 200 may further include a regulator (not shown) for supplying power. In particular, the controller 220 may be implemented to include a medium access control (MAC) layer. The PHY layer 210 may be configured to receive or transmit signals from or to another communication node. The controller 220 may be configured to control the PHY layer unit 210 and perform various functions (e.g., an infotainment function, or the like.). The PHY layer unit 210 and the controller unit 220 may be implemented as one system on chip (SoC), or alternatively may be implemented as separate chips.

The PHY layer unit 210 and the controller unit 220 may be connected via a media independent interface (MII) 230. The MII 230 may include an interface defined in the IEEE 802.3 and may include a data interface and a management interface between the PHY layer unit 210 and the controller unit 220. One of a reduced MII (RMII), a gigabit MII (GMII), a reduced GMII (RGMII), a serial GMII (SGMII), a 10 GMII (XGMII) may be used instead of the MII 230. The data interface may include a transmission channel and a reception channel, each of which may have independent clock, data, and control signal. The management interface may include a two-signal interface, one signal for the clock and one signal for the data.

The PHY layer unit 210 may include a PHY layer interface 211, a PHY layer processor 212, and a PHY layer memory 213. The configuration of the PHY layer unit 210 is not limited thereto, and the PHY layer unit 210 may be configured in various ways. The PHY layer interface 211 may be configured to transmit a signal received from the controller 220 to the PHY layer processor 212 and transmit a signal received from the PHY layer processor 212 to the controller 220. The PHY layer processor 212 may be configured to control operations of the PHY layer interface 211 and the PHY layer memory 213. The PHY layer processor 212 may be configured to modulate a signal to be transmitted or demodulate a received signal. The PHY layer processor 212 may be configured to control the PHY layer memory 213 to input or output a signal. The PHY layer memory 213 may be configured to store the received signal and output the stored signal based on a request from the PHY layer processor 212.

The controller unit 220 may be configured to monitor and control the PHY layer unit 210 using the MII 230. The controller unit 220 may include a controller interface 221, a controller processor 222, a main memory 223, and an auxiliary memory 224. The controller processor 222 is an electric circuitry which performs various functions described below. The configuration of the controller unit 220 is not limited thereto, and the controller 220 may be configured in various ways. The controller interface 221 may be configured to receive a signal from the PHY layer unit 210 (e.g., the PHY layer interface 211) or an upper layer (not shown), transmit the received signal to the controller processor 222, and transmit the signal received from the controller processor 222 to the PHY layer unit 210 or the upper layer. The controller processor 222 may further include independent memory control logic or integrated memory control logic for controlling the controller interface 221, the main memory 223, and the auxiliary memory 224. The memory control logic may be implemented to be included in the main memory 223 and the auxiliary memory 224 or may be implemented to be included in the controller processor 222.

Each of the main memory 223 and the auxiliary memory 224 may be configured to store a signal processed by the controller processor 222 and may be configured to output the stored signal based on a request from the controller processor 222. The main memory 223 may be a volatile memory (e.g., RAM) configured to temporarily store data required for the operation of the controller processor 222. The auxiliary memory 224 may be a non-volatile memory in which an operating system code (e.g., a kernel and a device driver) and an application program code for performing a function of the controller 220 may be stored. A flash memory having a high processing speed, a hard disc drive (HDD), or a compact disc-read only memory (CD-ROM) for large capacity data storage may be used as the non-volatile memory. Typically, the controller processor 222 may include a logic circuit having at least one processing core. A core of an Advanced RISC Machines (ARM) family or a core of an Atom family may be used as the controller processor 222.

Hereinafter, a method performed at a communication node belonging to a vehicle network and a corresponding counterpart communication node will be described. Hereinafter, even when a method (e.g., transmission or reception of a signal) to be performed at a first communication node is described, a corresponding second communication node may perform a method (e.g., reception or transmission of the signal) corresponding to the method performed at the first communication node. That is, when an operation of the first communication node is described, the corresponding second communication node may perform an operation corresponding to the operation of the first communication node. Conversely, when an operation of the second communication node is described, the corresponding first communication node may perform an operation corresponding to the operation of the second communication node.

FIG. 3 is a block diagram illustrating an embodiment of a communication node for which a backup path is configured.

As shown in FIG. 3, a communication node 300 may be a switch or an end node. The communication node 300 may support the IEEE 802.1CB standard. The communication node 300 may comprise an application layer unit 301, a controller unit 302, PHY layer units 303 and 304, and a medium dependent interface (MDI). The PHY layer units 303 and 304 may be the same as or similar to the PHY layer unit 210 described with reference to FIG. 2. The controller unit 302 may be the same as or similar to the controller unit 220 described with reference to FIG. 2. The application layer unit 301 may be connected to the controller unit 302, and the PHY layer units 303 and 304 may also be connected to the controller unit 302.

The controller unit 302 and the PHY layer units 303 and 304 may be connected via an xMII/SPI or the like. The application layer unit 301 and the controller unit 302 may be connected via the MDI.

The PHY layer unit 303 may configure a primary path, and the PHY layer unit 304 may configure a backup path. The primary path and the backup path may be determined by the application layer unit 301 or may be preconfigured. The application layer unit 301 may configure the primary path and the backup path through the MDI. That is, the application layer unit 301 may configure a path through which PHY layer unit as the primary path and a path through which PHY layer unit as the backup path.

When a path (i.e., primary path or backup path) fails, the PHY layer units 303 and 304 may inform the application layer unit 301 via the MDI that the path (i.e., primary path or backup path) fails. That is, the PHY layer units 303 and 304 may transmit a failure alert through the MDI when a failure occurs in a path, and the application layer unit 301 may recognize that the corresponding path fails based on the failure alert.

If transmission speeds of the PHY layer units 303 and 304 are the same, the application layer unit 301 may configure any unit to be responsible for the primary path. On the other hand, when the transmission speeds of the PHY layer units 303 and 304 are different, the application layer unit 301 may configure a path through the PHY layer unit having a higher transmission speed as the primary path. For example, when the transmission speed of the PHY layer unit 303 is 100 Mbps and the transmission speed of the PHY layer unit 304 is 10 Mbps, the application layer unit 301 may configure the path through the PHY layer unit 303 as the primary path, and configure the path through the PHY layer unit 304 as the backup path.

If both the primary path and the backup path operate normally, only the primary path may be active, and the backup path may be inactive. When the primary path fails, the backup path may be activated. The activation of the backup path may be performed via the MDI. In the communication through the primary path, both a MAC interface and a link may be activated. That is, when a switch transmits a signal to an end node, a PHY layer unit of the end node can receive the signal, and a controller unit of the end node can receive the signal from the PHY layer unit and identify a payload of the signal.

On the other hand, in the communication through the backup path, only a link may be activated. That is, when a switch transmits a signal to an end node, a PHY layer unit of the end node can identify a destination (e.g., end node ID) of the signal, and only if the destination of the signal is the same as its ID, the PHY layer unit may transfer the signal to a controller unit of the end node. If the destination of the signal is not the same as its ID, the end node may transfer the signal to a next end node connected to the backup path, rather than transferring the signal to the controller unit.

When the PHY layer unit 303 is responsible for the primary path, if the primary path fails, the communication node 300 may transmit a signal through the backup path of the PHY layer unit 304. In this case, when the transmission speed of the backup path is lower than the transmission speed of the primary path, the communication node 300 may perform transmission and reception only for a predetermined important signal. It may be determined whether a signal is important or not according to whether the signal meets a predetermined threshold. For example, if an importance level given to the signal is higher than a predetermined threshold, the signal may be determined to be an important signal, but if the importance level given to the signal is lower than the predetermined threshold, the signal may be determined not to be an important signal. The application layer unit 301 may have a single MAC/IP address. A vehicle network for which the backup path is configured may be as follows.

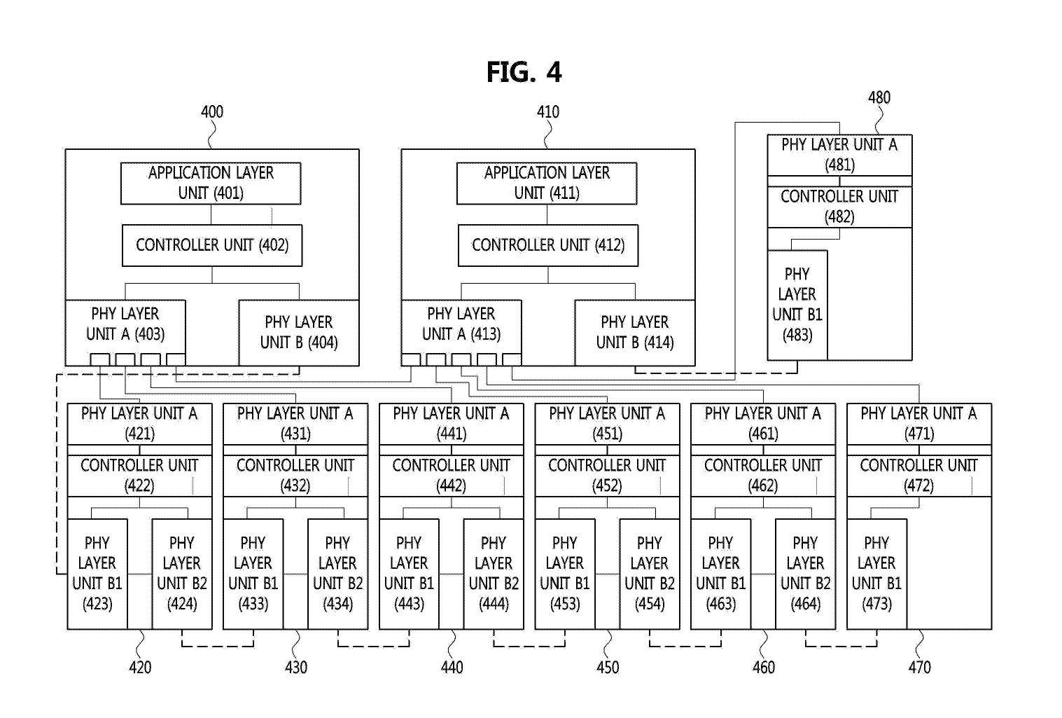

FIG. 4 is a block diagram illustrating a first embodiment of a vehicle network.

As shown in FIG. 4, a vehicle network may support the IEEE 802.1CB, and comprise a plurality of switches (e.g., switch #1 400, switch #2 410) and a plurality of end nodes (e.g., end node #1 420, end node #2 430, end node #3 440, end node #4 450, end node #5 460, end node #6 470, and end node #7 480. A structure of each of the plurality of switches and the plurality of end nodes may be the same as or similar to the structure of the communication node 300 of FIG. 3.

Each of the links between PHY layer units A (e.g., 403, 413, 421, 431, 441, 451, 461, 471, and 481) may be configured as a primary path, and each of the links between PHY layer units B (e.g., 404, 414, 423, 424, 433, 434, 443, 444, 453, 454, 463, 464, 473, and 483) may be configured as a backup path. The end node #1 420, end node #2 430, end node #3 440, end node #4 450, end node #5 460, end node #6 470, and end node #7 480 may be connected in a daisy chain scheme through the backup paths.

The switch #1 400 may be connected to the switch #2 410, the end node #1 420, the end node #2 430, and the end node #3 440, and the switch #2 410 may be connected to the switch #1 400, the end node #4 450, the end node #5 460, the end node #6 470, and the end node #7 480.

The PHY layer unit A 403 of the switch #1 400 may be connected to the PHY layer unit A 421 of the end node #1 420, the PHY layer unit A 431 of the end node #2 430, and the PHY layer unit A 441 of the end node #3 440 through the primary paths. The PHY layer unit A 413 of the switch #2 410 may be connected to the PHY layer unit A 451 of the end node #4 450, the PHY layer unit A 461 of the end node #5 460, the PHY layer unit A 471 of the end node #6 470, and the PHY layer unit A 481 of the end node #7 480 through the primary paths.

The PHY layer unit B 404 of the switch #1 400 may be connected to the PHY layer unit B1 423 of the end node #1 420 through the backup path. The PHY layer unit B2 424 of the end node #1 420 may be connected to the PHY layer unit B1 433 of the end node #2 430 through the backup path. The PHY layer unit B2 434 of the end node #2 430 may be connected to the PHY layer unit B1 443 of the end node #3 440 through the backup path. The PHY layer unit B2 444 of the end node #3 440 may be connected to the PHY layer unit B1 453 of the end node #4 450 through the backup path. The PHY layer unit B2 454 of the end node #4 450 may be connected to the PHY layer unit B1 463 of the end node #5 460 through the backup path. The PHY layer unit B2 464 of the end node #5 460 may be connected to the PHY layer unit B1 473 of the end node #6 470 through the backup path. The PHY layer unit B 414 of the switch #2 410 may be connected to the PHY layer unit B1 483 of the end node #7 480 through the backup path.

Hereinafter, embodiments of a communication method via a primary path and a backup path between a switch and an end node will be described.

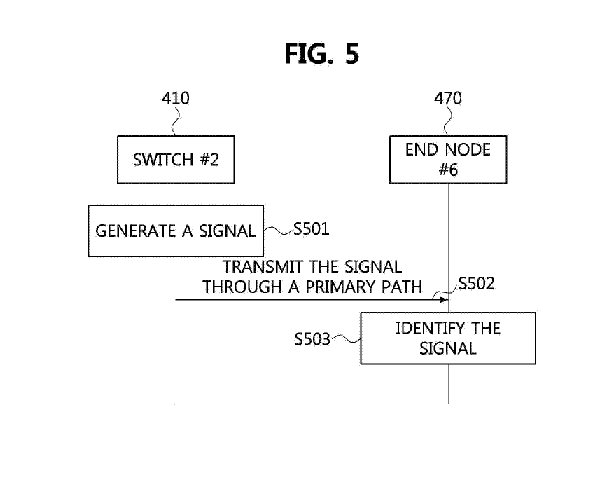

FIG. 5 is a sequence chart illustrating an embodiment of a communication method through a primary path between a switch and an end node in the vehicle network of FIG. 4.

As shown in FIGS. 4 and 5, the PHY layer unit A 413 of the switch #2 410 may be connected to the PHY layer unit A 471 of the end node #6 470. The switch #2 410 may generate a signal (S501), and may transmit the generated signal to the end node #6 470 through the PHY layer unit A 413 (S502).

The link between the PHY layer unit A 413 and the PHY layer unit A 471 may be the primary path. The end node #6 470 may receive the signal from the switch #2 410 through the PHY layer unit A 471. The PHY layer unit A 471 may transfer the received signal to the controller unit 472. The controller unit 472 may identify the received signal (S503).

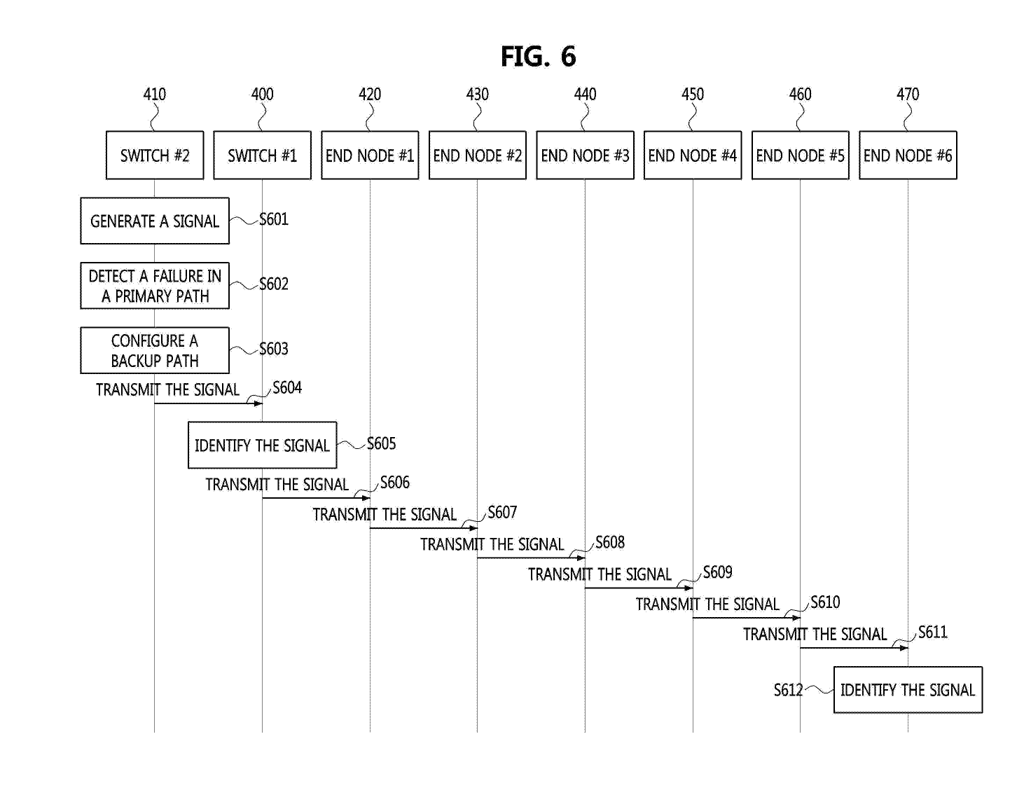

FIG. 6 is a sequence chart illustrating a first embodiment of a communication method through a backup path between a switch and an end node in the vehicle network of FIG. 4.

As shown in FIG. 6, the PHY layer unit A 413 of the switch #2 410 may be connected to the PHY layer unit A 471 of the end node #6 470. However, it may be assumed here that the path between the PHY layer unit A 413 and the PHY layer unit A 471 fails. The switch #2 410 may generate a signal to be transmitted to the end node #6 470 (S601). The switch #2 410 may attempt to transmit the signal through the primary path (i.e., the switch #2 may attempt to transmit the signal through PHY layer unit A 413). The PHY layer unit A 413 may attempt to transmit the signal to the PHY layer unit A 471. Here, when the path between the PHY layer unit A 413 and the PHY layer unit A 471 fails, the PHY layer unit A 413 may inform the controller unit 412 that the path between the PHY layer unit A 413 and the PHY layer unit A 471 fails. The controller unit 412 may then recognize that the path between the PHY layer unit A 413 and the PHY layer unit A 471 fails (S602).

Since the primary path between the switch #2 410 and the end node #6 470 (i.e., the path between the PHY layer unit A 413 and the PHY layer unit A 471) fails, the backup path between the switch #2 410 and the end node #6 470 may be configured (S603). The backup path between the switch #2 410 and the end node #6 470 may be, for example: [switch #2 switch #1 end node #1 end node #2 end node #3 end node #4 end node #5 end node #6]. Here, the switch #1 400, the end node #1 420, the end node #2 430, the end node #3 440, the end node #4 450, the end node #5 460, and the end node #6 470 may be connected through the PHY layer units B (i.e., 404, 423, 424, 433, 434, 443, 444, 453, 454, 463, 464, and 473).

The PHY layer unit A 413 of the switch #2 410 may transmit a signal to the PHY layer unit A 403 of the switch #1 400 (S604). The PHY layer unit A 403 may receive the signal from the PHY layer unit A 413. The PHY layer unit A 403 may transfer the signal to the controller unit 402. The controller unit 402 may identify the path for the signal (S605).

The PHY layer unit B 404 of the switch #2 410 may transmit a signal to the PHY layer unit B1 423 of the end node #1 420 (S606). The PHY layer unit B1 423 may receive the signal from the switch #1 400. The PHY layer unit B1 423 may identify a destination of the signal (e.g., ID of the destination). Since the destination of the signal is included in a preamble of the signal, the PHY layer unit B1 423 may identify the destination of the signal. If the destination of the signal is not the end node #1 420, the end node #1 420 may transmit the received signal to the end node #2 430. For example, the PHY layer unit B1 423 of the end node #1 420 may transmit the signal to the PHY layer unit B2 424 of the end node #1 420, and the PHY layer unit B2 424 of the end node #1 420 may transmit the received signal to the PHY layer unit B1 433 of the end node #2 430 (S607). Here, the controller unit 422 of the end node #1 420 may operate in a sleep state. That is, the signal between the end nodes can be transmitted and received through the PHY layer units, so that if the destination ID indicated by the received signal is different from the ID of the end node, the controller unit of the end node may not be woken up.

The PHY layer unit B1 433 may receive the signal from the end node #1 420. The PHY layer unit B1 433 may identify a destination of the signal. Since the destination of the signal is included in a preamble of the signal, the PHY layer unit B1 433 may identify the destination of the signal. If the destination of the signal is not the end node #2 430, the end node #2 430 may transmit the received signal to the end node #3 440. For example, the PHY layer unit B1 433 of the end node #2 430 may transmit the signal to the PHY layer unit B2 434 of the end node #2 430, and the PHY layer unit B2 434 of the end node #2 430 may transmit the received signal to the PHY layer unit B2 443 of the end node #3 440 (S608). Here, the controller unit 432 of the end node #2 430 may operate in a sleep state.

The PHY layer unit B1 443 may receive the signal from the end node #2 430. The PHY layer unit B1 443 may identify a destination of the signal. Since the destination of the signal is included in a preamble of the signal, the PHY layer unit B1 443 may identify the destination of the signal. If the destination of the signal is not the end node #3 440, the end node #3 440 may transmit the received signal to the end node #4 450. For example, the PHY layer unit B1 443 of the end node #3 440 may transmit the signal to the PHY layer unit B2 444 of the end node #3 440, and the PHY layer unit B2 444 of the end node #3 440 may transmit the received signal to the PHY layer unit B2 453 of the end node #4 450 (S609). Here, the controller unit 442 of the end node #3 440 may operate in a sleep state.

The PHY layer unit B1 453 may receive the signal from the end node #3 440. The PHY layer unit B1 453 may identify a destination of the signal. Since the destination of the signal is included in a preamble of the signal, the PHY layer unit B1 453 may identify the destination of the signal. If the destination of the signal is not the end node #4 450, the end node #4 450 may transmit the received signal to the end node #5 460. For example, the PHY layer unit B1 453 of the end node #4 450 may transmit the signal to the PHY layer unit B2 454 of the end node #4 440, and the PHY layer unit B2 454 of the end node #4 450 may transmit the received signal to the PHY layer unit B1 463 of the end node #5 460 (S610). Here, the controller unit 452 of the end node #4 450 may operate in a sleep state.

The PHY layer unit B1 463 may receive the signal from the end node #4 450. The PHY layer unit B1 463 may identify a destination of the signal. Since the destination of the signal is included in a preamble of the signal, the PHY layer unit B1 463 may identify the destination of the signal. If the destination of the signal is not the end node #5 460, the end node #5 460 may transmit the received signal to the end node #6 470. For example, the PHY layer unit B1 463 of the end node #5 460 may transmit the signal to the PHY layer unit B2 464 of the end node #5 460, and the PHY layer unit B2 464 of the end node #5 460 may transmit the received signal to the PHY layer unit B1 473 of the end node #6 470 (S611). Here, the controller unit 462 of the end node #5 460 may operate in a sleep state.

The PHY layer unit B1 473 may receive the signal from the end node #5 460. The PHY layer unit B1 473 may identify a destination of the signal. Since the destination of the signal is included in a preamble of the signal, the PHY layer unit B1 473 may identify the destination of the signal. If the destination of the signal is the end node #6 470, the PHY layer unit B 473 may wake up the controller unit 472. The controller unit 472 may be woken up, and the PHY layer unit B 473 may transfer the signal to the controller unit 472 after the controller unit 472 wakes up. The controller unit 472 may identify the signal (S612).

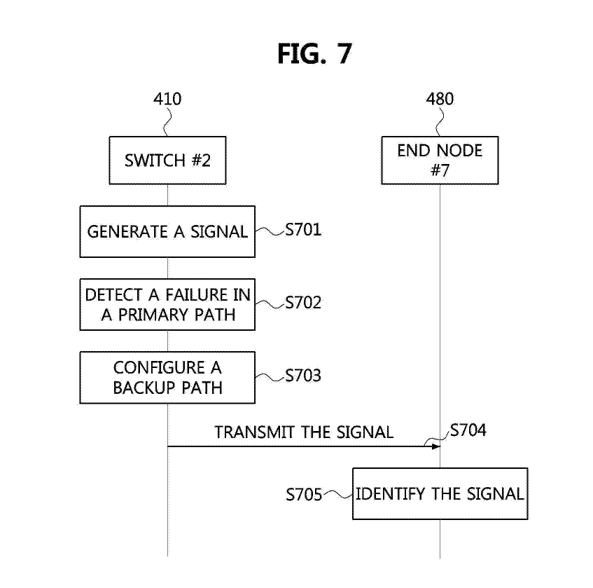

FIG. 7 is a sequence chart illustrating a second embodiment of a communication method through a backup path between a switch and an end node in the vehicle network of FIG. 4.

As shown in FIG. 7, the PHY layer unit A 413 of the switch #2 410 may be connected to the PHY layer unit A 481 of the end node #7 480. However, it may be assumed here that the path between the PHY layer unit A 413 and the PHY layer unit A 481 fails. The switch #2 410 may generate a signal to be transmitted to the end node #7 480 (S701). The switch #2 410 may attempt to transmit the signal through the primary path (i.e., the switch #2 may attempt to transmit the signal through PHY layer unit A 413). The PHY layer unit A 413 may attempt to transmit the signal to the PHY layer unit A 481. Here, when the path between the PHY layer unit A 413 and the PHY layer unit A 481 fails, the PHY layer unit A 413 may inform the controller unit 412 that the path between the PHY layer unit A 413 and the PHY layer unit A 481 fails. The controller unit 412 may then recognize that the path between the PHY layer unit A 413 and the PHY layer unit A 481 fails (S702).

Since the primary path between the switch #2 410 and the end node #7 480 (i.e., the path between the PHY layer unit A 413 and the PHY layer unit A 481) fails, the backup path between the switch #2 410 and the end node #7 480 may be configured (S703). The backup path between the switch #2 410 and the end node #7 480 may be the path between the PHY layer unit B 414 of the switch #2 410 and the PHY layer unit B 483 of the end node #7 480.

The PHY layer unit B 414 of the switch #2 410 may transmit a signal to the PHY layer unit B 483 of the end node #7 480 (S704). The PHY layer unit B 483 may receive the signal from the PHY layer unit B 414. The PHY layer unit B 483 may transfer the signal to the controller unit 482. The controller unit 482 may identify the signal (S705).

Here, there may be a case where the transmission speeds of the primary path and the backup path are different (e.g., the transmission speed of the primary path is 100 Mbps and the transmission speed of the backup path is 10 Mbps). In the following, it is assumed that the transmission speed of the primary path is higher than the transmission speed of the backup path. When signals to be transmitted to an end node for which a primary path fails are received from other communication node (e.g., switch #1 400, end node #1 420, end node #2 430, end node #3 440, end node #4 450, end node #5 460, or end node #7 470), the switch #2 410 may selectively transmit only important signals among the received signals to the end node #7 480. It may be determined according to a preconfigured reference whether the received signal is an important signal.

The methods according to embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software. Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the operation of the present disclosure, and vice versa.

While the embodiments of the present disclosure and their advantages have been described in detail above, it should be understood that various changes, substitutions and alterations may be made herein without departing from the scope of the disclosure.

What is claimed is:

1. An operation method of a switch in a vehicle network, the operation method comprising:
transmitting a first signal to a first end node through a first path connecting the switch and the first end node;
detecting a failure in the first path;
configuring a second path connecting the switch and the first end node;
receiving a second signal from a second end node;
determining whether a destination of the second signal is the first end node; and
in response to determining that the destination of the second signal is the first end node, transmitting the second signal through the second path.

2. The operation method according to claim 1, wherein a preamble of the second signal includes an identifier of the destination, and the identifier is used to determine whether the destination of the second signal is the first end node.

3. The operation method according to claim 1, wherein the first path and the second path have different transmission speeds.

4. The operation method according to claim 1, wherein the second path includes a section in which a plurality of end nodes are connected in a daisy chain scheme.

5. The operation method according to claim 1, wherein the switch includes a controller unit, a first physical (PHY) layer unit, and a second PHY layer unit, the first path is connected to the first PHY layer unit, and the second path is connected to the second PHY layer unit.

6. The operation method according to claim 5, wherein the detecting of the failure comprises: informing, by the first PHY layer unit, the controller unit of the failure in the first path through a medium dependent interface (MDI), such that the controller unit recognizes the failure in the first path.

7. The operation method according to claim 1, wherein the transmitting of the second signal through the second path comprises transmitting the second signal through the second path in response to determining that the second signal meets a preconfigured threshold.

8. The operation method according to claim 5, further comprising:
receiving, by the first PHY layer unit, a third signal from a third end node;
transferring, by the first PHY layer unit, the third signal to the third end node;
identifying, by the controller unit, a destination and a path of the third signal;
selecting a PHY layer unit among the first and second PHY layer units for transmitting the third signal based on the destination and the path of the third signal; and
transmitting the third signal through the selected PHY layer unit.

9. A switch in a vehicle network comprising a processor and a memory storing at least one instruction executable by the processor, wherein, when the at least one instruction is executed, the processor is configured to:
transmit a first signal to a first end node through a first path connecting the switch and the first end node;
detect a failure in the first path;
configure a second path connecting the switch and the first end node;
receive a second signal from a second end node;
determine whether a destination of the second signal is the first end node; and
in response to determining that the destination of the second signal is the first end node, transmit the second signal through the second path.

10. The switch according to claim 9, wherein a preamble of the second signal includes an identifier of the destination, and the identifier is used to determine whether the destination of the second signal is the first end node.

11. The switch according to claim 9, wherein the second path includes a section in which a plurality of end nodes are connected in a daisy chain scheme.

12. The switch according to claim 9, further comprising:
a controller unit;
a first physical (PHY) layer unit; and
a second PHY layer unit,
wherein the first path is connected to the first PHY layer unit, and the second path is connected to the second PHY layer unit.

13. The switch according to claim 12, wherein the processor is further configured to cause the first PHY layer unit to inform the controller unit of the failure in the first path through a medium dependent interface (MDI), such the controller unit recognizes the failure in the first path.

14. The switch according to claim 12, wherein the processor is further configured to transmit the second signal through the second path in response to determining that the second signal meets a preconfigured threshold.

15. The switch according to claim 12, wherein the processor is further configured to:
cause the first PHY layer unit to receive a third signal from a third end node;
cause the first PHY layer unit to transfer the third signal to the third end node;
cause the controller unit to identify a destination and a path of the third signal;
select a PHY layer unit among the first and second PHY layer units for transmitting the third signal based on the destination and the path of the third signal; and
transmit the third signal through the selected PHY layer unit.

16. An operation method of a first end node in a vehicle network, wherein the first end node includes a first physical (PHY) layer unit, a second PHY layer unit, and a controller unit, the first PHY unit is connected to a switch, and the second PHY unit is connected to second and third end nodes, the operation method comprising:
receiving, by the second PHY unit, a signal from the second end node;
identifying, by the second PHY layer unit, a destination identifier (ID) from the signal;
determining whether the destination ID is different from an ID of the first end node; and
in response to determining that the destination ID is different from the ID of the first end node, transmitting the signal to the third end node.

17. The operation method according to claim 16, further comprising:
detecting a failure in the first PHY layer unit;
informing, by the first PHY layer unit, the controller unit of the failure in the first PHY layer unit through a medium dependent interface (MDI);
recognizing, by the controller unit, the failure in the first PHY layer unit; and
transmitting, by the second PHY layer unit, the signal.

18. The operation method according to claim 17, wherein a transmission speed of the first PHY layer unit is higher than a transmission speed of the second PHY layer unit.

19. The operation method according to claim 17, wherein the first PHY layer unit and the second PHY layer unit are connected to the controller unit via a media independent interface (xMII).

20. The operation method according to claim 16, wherein the first, second, and third end nodes are connected in a daisy chain scheme.
